(19) United States
(12) Patent Application Publication
(10) Pub. No.: US 2025/0373110 A1
(43) Pub. Date: Dec. 4, 2025

(54) METHOD FOR CONNECTING A METAL HOUSING AND A PLASTIC COVER, AND METAL HOUSING COMPRISING A PLASTIC COVER

(71) Applicant: Schaeffler Technologies AG & Co. KG, Herzogenaurach (DE)

(72) Inventors: Marc Beyer, Haguenau (FR); Pascal Verbücheln, Bühl (DE); Jean-Georges Friedmann, Hatten (FR)

(73) Assignee: Schaeffler Technologies AG & Co. KG, Herzogenaurach (DE)

(21) Appl. No.: 18/873,790

(22) PCT Filed: Jun. 27, 2023
(86) PCT No.: PCT/DE2023/100481

§ 371 Date: Dec. 11, 2024

(30) Foreign Application Priority Data
Jul. 1, 2022 (DE) 10 2022 116 453.5

(51) Int. Cl. H02K 5/10; H02K 5/02; H02K 15/14

(52) U.S. Cl. CPC H02K 5/10; H02K 5/02; H02K 15/14

(57) ABSTRACT

The disclosure relates to a method for connecting a metal housing and a plastic cover. A metal sleeve having a groove extending at least in part in a peripheral direction is at least partially overmolded with a plastic to form the plastic cover. The plastic cover is pressed axially with the metal sleeve into the metal housing to locate the metal sleeve on at least part of a periphery of the metal housing. The disclosure also relates to a metal housing having the plastic cover, and the metal sleeve is located at least in part between the metal housing and the plastic cover. The metal sleeve has a groove extending at least in part peripherally and is at least partially overmolded with plastic, and the metal sleeve is located on at least part of the periphery of the metal housing and has an interference fit in the metal housing.

### CROSS-REFERENCE TO RELATED APPLICATIONS

This application is the U.S. National Phase of PCT Application No. PCT/DE2023/100481 filed on Jun. 27, 2023, which claims priority to DE 10 2022 116 453.5 filed on Jul. 1, 2022, the entire disclosures of which are incorporated by reference herein.

### TECHNICAL FIELD

The disclosure relates to a method for connecting a metal housing and a plastic cover. Furthermore, the disclosure relates to a metal housing having a plastic cover.

### BACKGROUND

Usually, metal housings and plastic covers are screwed together or joined in such a way that the plastic cover is pressed into the metal housing. However, an interference fit between the metal housing and the plastic cover is unfavorable due to the different materials of metal and plastic and can lead to a reduced holding force.

DE 10 2020 131 326 A1 discloses an electric motor for driving an actuator of a motor vehicle. The electric motor has a housing with a housing base body and a plug-in module that forms a housing wall of the housing and encloses an interior together with the housing base body. The plug-in module has a connector that is arranged outside of the interior. Furthermore, a screw having a screw head is provided, by means of which the plug-in module is attached to the housing base body, wherein the screw is arranged completely within the interior.

### SUMMARY

The object of the present disclosure is to provide an alternative method for connecting a metal housing and a plastic cover, as well as an alternative metal housing having a plastic cover. In particular, the connection between the metal housing and the plastic cover should exhibit a high holding force and be particularly durable.

According to a method of the disclosure for connecting a metal housing and a plastic cover, the metal housing is provided, i.e., essentially made of a metal material, and a metal sleeve with grooving extending at least partially in the circumferential direction is at least partially overmolded with a plastic material in order to form the plastic cover. The plastic cover is pressed axially into the metal housing with the metal sleeve so that the metal sleeve is arranged at least partially on the circumference of the metal housing.

The connection between the metal sleeve and the plastic material is form-fitting, because the metal sleeve is at least partially or completely overmolded with plastic material. In contrast, the connection between the metal sleeve and the metal housing is force-fitting, because the plastic cover is pressed axially into the metal housing so that an interference fit is formed between the metal sleeve and the metal housing.

The metal sleeve, which is spatially arranged between the metal housing and the plastic cover, creates a particularly durable connection between the metal housing and the plastic cover and exhibits a high holding force. Furthermore, the metal sleeve reliably prevents damage to the plastic cover when it is pressed into the metal housing. The metal housing and the metal sleeve can be made of the same material. For example, the metal housing and the metal sleeve are made of an aluminum alloy and thus have identical material properties, in particular identical coefficients of thermal expansion. Because the coefficients of thermal expansion are identical, the metal housing having the plastic cover can be used for applications that have a wide temperature range without affecting the connection between the metal housing and the plastic cover.

Pressing the plastic cover into the metal housing means that the plastic cover and the metal housing are axially displaced relative to one another, i.e., either both components are moved towards one another or at least one of the two components is moved in the direction of the other component, wherein a force-fitting connection, i.e., an interference fit, is realized at the circumferential surfaces of the metal housing and the metal sleeve. It consequently makes no difference whether the plastic cover is pressed axially into the metal housing or whether the metal housing is pressed axially onto the plastic cover. In particular, the metal housing and the plastic cover are designed to be cylindrical.

Grooving is to be understood as a type of toothing, i.e., a structured region with alternately arranged ridges and recesses in the circumferential direction. The geometry of the grooves or teeth can be rounded or angular and is designed to be overmolded with plastic material in order to better transfer any torques through the form fit. The grooving also strengthens the form-fit connection between the metal sleeve and the plastic material. The grooving on the metal sleeve can be completely overmolded with plastic material. In other words, the ridges and recesses are completely covered with plastic material.

According to an example embodiment, the grooving is formed on an axially delimited section of an inner circumferential surface of the metal sleeve. For example, the grooving on the inner circumferential surface of the metal ring is designed to be completely circumferential. Alternatively, multiple grooving regions are arranged spaced apart from one another in the circumferential direction.

According to an example embodiment, an at least partially circumferential shoulder is formed on the metal sleeve, and the plastic cover is pressed axially into the metal housing until the at least partially circumferential shoulder abuts against the end face of the metal housing. In other words, the cylindrical metal sleeve has a shoulder, and the shoulder can be formed on the outer circumferential surface of the metal sleeve and thus extends radially outwards. The metal sleeve therefore comes to rest against the metal housing both on the circumference and on the end face. The metal sleeve can be formed from an aluminum profile, and the at least partially circumferential shoulder on the aluminum profile can be produced by means of a forming process. For example, the shoulder on the metal sleeve is designed to be completely circumferential. Alternatively, multiple shoulders are arranged spaced apart from one another in the circumferential direction.

According to an example embodiment, a sealing ring is arranged radially between the metal housing and the plastic cover. The sealing ring can be arranged in a groove provided for it on the plastic cover and is made of a rubber material. In particular, the sealing ring comes into contact between the inner circumferential surface of the metal housing and the outer circumferential surface of the plastic cover in a fluid-tight and circumferential manner.

A metal housing according to the disclosure having a plastic cover has a metal sleeve, which is arranged at least partially between the metal housing and the plastic cover, wherein the metal sleeve has an at least partially circumferential grooving, which is at least partially overmolded with plastic material, wherein the metal sleeve is arranged at least on the circumference of the metal housing and exhibits an interference fit in the metal housing. The interference fit between the metal housing and the metal sleeve of the plastic cover ensures that the metal housing and the plastic cover are connected in a force-fitting manner indirectly via the metal sleeve.

An electric machine according to the disclosure has a metal housing according to the invention having a plastic cover. In particular, the metal housing according to the disclosure having the plastic cover is manufactured using the method according to the disclosure. For example, the electric machine is intended for a motor vehicle, in particular for driving an actuator. The plastic cover of the metal housing is designed as a plug-in module.

### BRIEF DESCRIPTION OF THE DRAWINGS

Further measures to improve the disclosure are shown in more detail below together with the description of an example embodiment of the disclosure based on the figures. In the figures:

FIG. 1 shows a schematic perspective view of a metal sleeve,

FIG. 2 shows a schematic perspective cross-sectional view of a plastic cover with the metal sleeve according to FIG. 1, and

FIG. 3 shows a schematic cross-sectional view of a section of a metal housing with the plastic cover according to FIG. 2.

### DETAILED DESCRIPTION

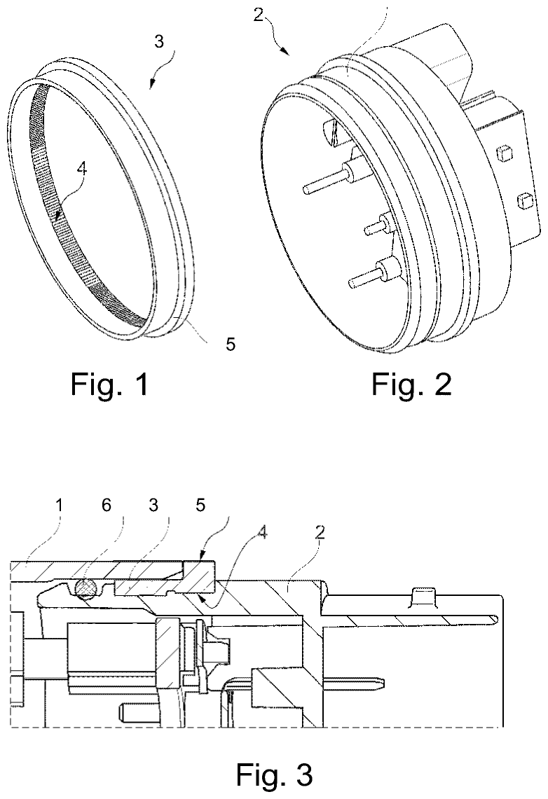

According to FIG. 1, a cylindrical metal sleeve 3 having grooving 4 extending in the circumferential direction on an inner circumferential surface and a shoulder 5 extending in the circumferential direction on an outer circumferential surface can be made of an aluminum alloy.

FIG. 2 shows the plastic cover 2, which is formed by overmolding the metal sleeve 3 shown in FIG. 1 with plastic material. In other words, the metal sleeve 3 is placed in an injection mold and overmolded with plastic material in order to create the plastic cover 2. The inner circumferential surface of the metal sleeve 3 and thus also the grooving 4 formed on the inner circumferential surface of the metal sleeve 3 is completely overmolded with plastic material and is therefore not shown as visible in FIG. 2. No plastic material is provided on the outer circumferential surface of the metal sleeve 3, therefore, the outer circumferential surface is plastic-free.

FIG. 3 shows the plastic cover 2 arranged in a metal housing 1, wherein the metal sleeve 3 is arranged with the outer circumferential surface on the inner circumferential surface of the metal housing 1. The plastic cover 2, i.e., the metal sleeve 3 overmolded with plastic material, exhibits an interference fit with the metal housing 1. The shoulder 5 on the outer circumferential surface of the metal sleeve 3 effects a local increase in the outer diameter of the metal sleeve 3. The plastic cover 2 is pressed axially into the metal housing 1 until the shoulder 5 of the metal sleeve 3 abuts against the end face of the metal housing 1. Thus, the shoulder 5 on the metal sleeve 3 serves as an axial stop surface for positioning the plastic cover 2 in the metal housing 1. The metal sleeve 3 comes to rest against the metal housing 1 both on the circumference and on the end face.

Furthermore, a sealing ring 6 is arranged radially between the metal housing 1 and the plastic cover 2, which comes into contact in a fluid-tight and circumferential manner between the inner circumferential surface of the metal housing 1 and the outer circumferential surface of the plastic cover 2.

The metal housing 1 and the metal sleeve 3 are made of the same material and thus have identical coefficients of thermal expansion, which improves the durability and holding force of the interference fit. In the present case, the metal housing 1 and the metal sleeve 3 are made of an aluminum alloy.

### LIST OF REFERENCE SYMBOLS

1 Metal housing
2 Plastic cover
3 Metal sleeve
4 Grooving
5 Shoulder on the metal sleeve
6 Sealing ring

1. A method for connecting a metal housing and a plastic cover, comprising:
providing the metal housing,
providing a metal sleeve with toothing extending in a circumferential direction, the metal sleeve at least partially overmolded with a plastic material so as to form the plastic cover,
axially pressing the plastic cover into the metal housing via the metal sleeve so that the metal sleeve is fixedly arranged at least on the a circumference of the metal housing.

2. The method according to claim 1, wherein the toothing is formed on an axially delimited section of an inner circumferential surface of the metal sleeve.

3. The method according to claim 2, wherein the toothing on the metal sleeve is completely overmolded with the plastic material.

4. The method according to claim 3, wherein a circumferential shoulder is formed on the metal sleeve, and the plastic cover is pressed axially into the metal housing until the circumferential shoulder abuts against an end face of the metal housing.

5. The method according to claim 4, wherein a sealing ring is arranged radially between the metal housing and the plastic cover.

6. A housing assembly, comprising:
a metal housing,
a plastic cover fixed to the metal housing, and
a metal sleeve (arranged at least partially between the metal housing and the plastic cover, the metal sleeve having circumferential toothing, which is at least partially overmolded with plastic material of the plastic cover, and the metal sleeve is fixedly attached to a circumference of the metal housing and forms an interference fit in the metal housing.

7. The housing assembly according to claim 6, wherein the metal housing and the metal sleeve are made of a same material.

8. The housing assembly according to claim 7, wherein the metal housing and the metal sleeve are made of an aluminum alloy.

9. The housing assembly according to claim 6, wherein the metal sleeve rests against the metal housing both on the circumference of the metal housing and on an end face of the metal housing.

10. An electric machine having the housing assembly according to claim 6.

11. The method according to claim 4, wherein an outer peripheral surface of the metal sleeve is plastic-free.

12. The housing assembly according to claim 6, wherein the at least partially circumferential toothing is arranged on an inner peripheral surface of the metal sleeve.

13. The housing assembly according to claim 12, wherein an outer peripheral surface of the metal sleeve is plastic-free.

14. A housing assembly, comprising:
a metal housing,
a plastic cover attached to the metal housing,
a metal sleeve arranged radially between the metal housing and the plastic cover, the metal sleeve:
having circumferentially spaced toothing arranged on an inner peripheral surface, the circumferentially spaced toothing at least partially overmolded with plastic material of the plastic cover, and
fixedly attached to a circumference of the metal housing and forming an interference fit in the metal housing, and
wherein, an outer peripheral surface of the metal sleeve is plastic free.

15. The housing assembly according to claim 14, wherein the metal housing, the plastic cover, and the metal sleeve are cylindrical.

16. The housing assembly according to claim 15, wherein the outer peripheral surface of the metal sleeve forms the interference fit with the metal housing.

17. The housing assembly according to claim 16, wherein the circumferentially spaced toothing is formed on an axially delimited section of an inner circumferential surface of the metal sleeve.

18. The housing assembly according to claim 17, wherein a circumferential shoulder is formed on the outer peripheral surface of the metal sleeve, and the plastic cover is pressed axially into the metal housing until the circumferential shoulder abuts against an end face of the metal housing.

19. The housing assembly according to claim 18, further comprising a sealing ring arranged radially between an inner circumferential surface of the metal housing and an outer circumferential surface of the plastic cover.

20. The housing assembly according to claim 19, wherein the metal sleeve is disposed within the metal housing and extends outwardly from an end of the metal housing in an axial direction.
